(19) United States
(12) Patent Application Publication
(10) Pub. No.: US 2015/0134244 A1
(43) Pub. Date: May 14, 2015

(54) Method for Predicting Travel Destinations Based on Historical Data

(71) Applicant: Mitsubishi Electric Research Laboratories, Inc., Cambridge, MA (US)

(72) Inventors: John R. Hershey, Winchester, MA (US); Lingbo Li, Durham, NC (US); William Li, Cambridge, MA (US)

(73) Assignee: Mitsubishi Electric Research Laboratories, Inc., Cambridge, MA (US)

(21) Appl. No.: 14/077,689

(22) Filed: Nov. 12, 2013

(51) Int. Cl. G01C 21/36

(52) U.S. Cl. CPC G01C 21/3617
USPC 701/489

(57) ABSTRACT

The embodiments of the invention provide a method in a navigation system, for predicting travel destinations according to a history of destinations. A model used for the prediction incorporates a database of destinations, which can include favorite, i.e., most probable, destinations for a user. The model also uses a context that can include features such as a current time of day, day of week, current location, current direction, past location, weather, and so on. The model infers the destination and destination categories even when the destination is not known precisely. Specifically, a method predicts destinations during travel, based on feature vectors representing current states of the travel, probabilities of destinations and categories of the destinations using a predictive model representing previous states of the travel. A subset of the destinations and categories of the destinations with highest probabilities are output for user selection.

### FIELD OF THE INVENTION

The present invention relates generally to predicting travel destinations, and in particular, basing the predictions on historical data.

### BACKGROUND OF THE INVENTION

Navigation systems are replacing paper maps and charts to assist drivers and captains navigate through unfamiliar areas to unfamiliar destinations. Most navigation systems include a global positioning system (GPS) to determine an exact location of a vehicle, boat or plane. As an advantage, data in navigations system can be continuously updated, augmented with additional en-route information, and easily transferred between systems.

Typically, a destination is set by the operator or a passenger. The destination can be based a location name, address, telephone number, a pre-selected geographical point selected from a list of pre-registered destinations, and the like. The knowledge of a particular route, in conjunction with status and environment data, e.g., traffic, and weather, can be used to assist the operator navigator to a particular destination.

U.S. Pat. No. 7,233,861 describes a method for predicting destinations and receiving vehicle position data. The vehicle position data include a current trip that is compared to a previous trip to predict a destination for the vehicle. A path to the destination can also be suggested.

U.S Patent Publication 20110238289 describes a navigation device and method for predicting the destination of a trip. The method determines starting parameters including starting point, starting time and date of the trip. A prediction algorithm is generated by using information of a trip history.

U,S Patent Publication 20130166096 describes a predictive destination entry system for a vehicle navigation system to aid in obtaining a destination for the vehicle. The navigation system uses a prior driving history or habits. This information is used for making predictions for the current destination desired by a user of the vehicle. The information can be segregated into distinct user profiles and can include the vehicle location, previous driving history of the vehicle, previous searching history of a user of the vehicle, or sensory input relating to one or more characteristics of the vehicle.

### SUMMARY OF THE INVENTION

The embodiments of the invention provide a method in a navigation system, for predicting travel destinations according to a history of destinations. A model used for the prediction incorporates a database of destinations, which can include favorite, i.e., most probable, destinations for a user.

The model also uses a context that can include features such as a current time of day, day of week, current location, current direction, past location, weather, and so on. The model infers the destination even when the destination is not known precisely.

Specifically, a method predicts destinations during travel, based on feature vectors representing current states of the travel, probabilities of categories of the destinations using a predictive model based on previous states of the travel. A subset of the categories with highest probabilities are output for user selection.

### BRIEF DESCRIPTION OF THE DRAWINGS

FIG. 1 is a flow diagram of a method for predicting travel destinations based on historical data according to embodiments of the invention;

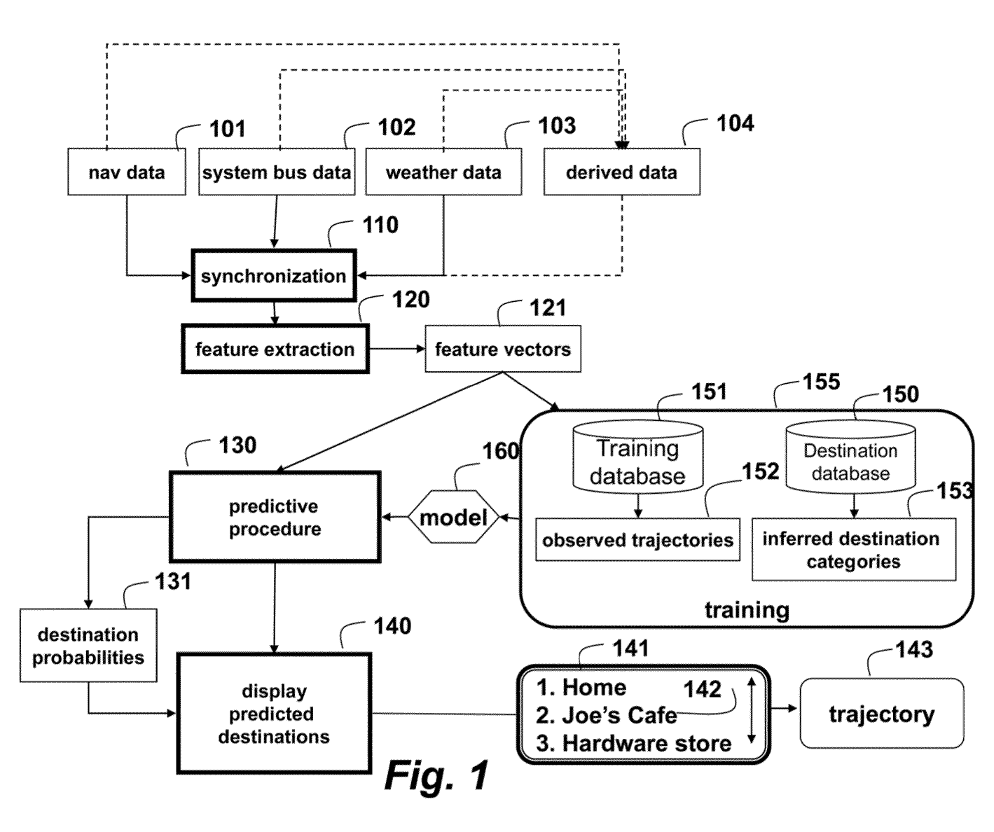

FIG. 2 is a hierarchical destination category prediction model according to embodiments of the invention; and

FIG. 3 is a destination category prediction model with destination category dependencies according to embodiments of the invention.

### DETAILED DESCRIPTION OF THE PREFERRED EMBODIMENTS

### Introduction

The embodiments of our invention provide a method in a navigation system, for predicting travel destinations according to a history of travel activity. In the examples described herein, the travel is performed by a vehicle. However, it is understood that other modes of travel can also be predicted by the methods described herein. The methods can be performed in a processor connected to memory, input/output interfaces connected by buses. Output devices can include displays or speakers to indicate the destinations to a user. Input devices can include location trajectories from a global positioning system (GPS) touch screens, keyboards and voice recognition systems to select a specific destination.

Method Overview

The method acquires navigation data 101, (vehicle) system bus data 102, weather data 103, and derived data. Some of the derived data can be obtained from the vehicle navigation system, vehicle buses, and weather data 101-103. The navigation system can include a GPS, as well as a wireless internet connection to various information servers. A vehicle bus is defined as any specialized internal communications network that interconnects components inside a vehicle (e.g., automobile, bus, train, industrial or agricultural vehicle, ship, or aircraft). The data are synchronized 110, and features are extracted 120 as feature vectors 121. Each feature vector collectively represents a previous state of the travel for some past time.

Training

During a training phase 155, which can be one time, intermittent, periodic or continuous, the features are stored in a training data base 151. The training also maintains a destination database 150 containing the locations, address, names, identifiers, categories associated with specific destinations, such as businesses, government facilities, residences, landmarks, and other geographically located entities. Such destination databases can also be located on a server. The destination categories can contain any semantic information relevant to destination selection, such as its type, quality, availability, and so on.

During the training, probabilities of destination categories are inferred 153. That is the probabilities are associated with categories of destinations. Probabilities of destination categories should not be confused with the identities of the destinations as usually found in prior art systems. The training also determines 152 observed trajectories during travel. In cases where the actual destination of the user is not known via the navigation user interface, the observed trajectories are used to infer a probabilities associated with each destination and its associated categories. The trajectories and the probabilistically inferred destination and destination categories that are inferred during training are used to construct a predictive model 160.

Operation

During operation, similar features of current states of actual travel are acquired in real-time and processed by a predictive procedure 130 to obtain probabilities 131 of destinations destination categories, and related actions, such as telephoning the destination. The predicted destinations, categories, and actions with the highest probabilities, e.g., the highest three, are displayed 140 or presented to the user as selection by other means on an output user interface 141, such as speech output. The number of selections with highest probabilities displayed can be user specified. Then, the user can select 142 a destination, destination category, or action using an input user interface, and routing information or a trajectory 143 can then be generated during the travel to the selected destination.

Theoretical Justification

The invention is based on the intuition that travelers exhibit regularity in their destination sequences, e.g.

home→drink/snack→work→store→home.

The embodiments of this invention take as input features derived from the current and past trajectories, such as the previous destinations, destination categories, as well as the time of day, day of week, status of the trip, direction of travel, and so-on. Prediction is treated as an inference task with variables representing the destination, and destination categories, as well as the ultimate location of arrival. When only the arrival location is observed, the training algorithm can infer the destination and destination categories as hidden variables.

Simplified Model

In a pair of random variables {x, s}, x represents the feature vector and s represent a location, e.g., longitude and latitude, e.g., an end point of a segment of a trip.

The feature vector x=[x₁, . . . , x_{F}] includes a trajectory identification (ID), segment ID for each trajectory, points ID for each segment, elevation, time, speed, and direction, and possibly their statistics, e.g., average, mean, deviation, etc., collectively a state of travel.

We infer a multinomial category (or “genre”) zε[1, . . . , C] of a destination d, which is a multinomial that indexes possible destinations from destination database, or a “favorite” destination obtained from a user.

We formulate this as a multinomial logistic regression model:

$$p ( z \vert x ) = \frac{exp ( {λ}_{z}^{T} φ ( x ) )}{{Z}_{A}} ,$$

where Λ=[λ₁, . . . λ_{C}]^{T}, λ are weights, and Z_{Λ}=Σ_{z}exp(λ_{z}^{T}φ(x)), and φ(x) is a vector-valued function of our input features x. Depending on the type of inference, we can also use a multinomial probit regression model, which is similar to multinomial logistic regression but may be more convenient for sampling-based methods.

Our intuition assumes that after the user has selected a category c with higher probabilities. the user most likely will select a destination d that is from that category:

$$p ( d \vert z ) ∝ \{ \begin{matrix}1 & z ∈ cat ( d ) \\ 0 & otherwise\end{matrix} ,$$

where “cat” is the set of categories identified with the destination d. This is a uniform multinomial over destinations consistent with the category c.

We assume that the user parks the vehicle at location s near the selected d. This can be modeled as

p(s|d)=N(s;loc(d),Σ),

where Σ=σ²I₂ and σ is the standard deviation of the distance a person parks away from their destination, and loc(d)=[dₗₐₜ, dₗₒₙ]^{T} is the location (latitude and longtitude) of the point of interest d.

Model Training

For training 155 such a model 160, we consider for example pairs xᵢ, sᵢ, where xᵢ is in the middle of a segment. An objective function to train is

$$\begin{matrix}= {max}_{Λ} {\sum }_{i}^{ } log p ( {x}_{i} , {s}_{i} ) = {\sum }_{i}^{ } log {\sum }_{{z}_{i} , {d}_{i}}^{ } p ( {z}_{i} \vert {x}_{i} ) p ( {d}_{i} \vert {x}_{i} ) p ( {s}_{i} \vert {d}_{i} ) \\ = {\sum }_{i}^{ } log {\sum }_{{z}_{i}}^{ } \frac{exp ( {λ}_{{z}_{i}}^{T} φ ( {x}_{i} ) )}{{\sum }_{z}^{ } exp ( {λ}_{z}^{T} φ ( {x}_{i} ) )} \frac{1}{\vert {𝒟}_{i} ( {z}_{i} ) \vert} ( 2 ) \\ {\sum }_{{d}_{i} ∈ {𝒟}_{i} ( {z}_{i} )}^{ } 𝒩 ( {s}_{i} ; loc ( {d}_{i} ) , \sum )\end{matrix} \qquad ( 1 )$$

where we only sum over a set of destination

Dᵢ(zᵢ)={dᵢ: |loc(dᵢ)−sᵢ|<5σ, and zᵢεcat(dᵢ)},

because p(z|d) and/or p(s|d) are zero or relatively small outside this set.

Regularization Approach

Logistic regression benefits with some form of L₁ and/or L₂ regularization. Transforming the features to a lower-dimensional subspace can also improve generalization performance.

The transformation model is

$$p ( z \vert x ) = \frac{exp ( {λ}_{z}^{T} A φ ( x ) )}{{Z}_{A , Λ}} ,$$

where A is a (R×F) matrix that is shared for all classes and all users. Usually, R<F to perform dimensionality reduction.

As an objective function, the model is

$$\begin{matrix}{max}_{A , Λ} {\sum }_{i}^{ } log p ( {x}_{i} , {s}_{i} ) = {\sum }_{i}^{ } log {\sum }_{{z}_{i} , {d}_{i}}^{ } p ( {z}_{i} \vert {x}_{i} ) p ( {d}_{i} \vert {x}_{i} ) p ( {s}_{i} \vert {d}_{i} ) \\ = {\sum }_{i}^{ } log {\sum }_{{z}_{i}}^{ } \frac{exp ( {λ}_{{z}_{i}}^{T} φ ( {x}_{i} ) )}{{\sum }_{z}^{ } exp ( {λ}_{z}^{T} φ ( {x}_{i} ) )} \frac{1}{\vert {𝒟}_{i} ( {z}_{i} ) \vert} ( 4 ) \\ {\sum }_{{d}_{i} ∈ {𝒟}_{i} ( {c}_{i} )}^{ } 𝒩 ( {s}_{i} ; loc ( {d}_{i} ) , \sum )\end{matrix} \qquad ( 3 )$$

We add L₁ and L₂ regularization so that the objective function becomes

$$\begin{matrix}{max}_{A , Λ} {\sum }_{i}^{ } log p ( {x}_{i} , {s}_{i} ) = {\sum }_{i}^{ } log {\sum }_{{z}_{i}}^{ } \frac{exp ( {λ}_{{z}_{i}}^{T} φ ( {x}_{i} ) )}{{\sum }_{z}^{ } exp ( {λ}_{z}^{T} φ ( {x}_{i} ) )} \frac{1}{\vert {𝒟}_{i} ( {z}_{i} ) \vert} \\ = {\sum }_{{d}_{i} ∈ {𝒟}_{i} ( {c}_{i} )}^{ } 𝒩 ( {s}_{i} ; loc ( {d}_{i} ) , \sum ) - \\ α {\sum }_{z}^{ } \vert {λ}_{z} \vert - β {\sum }_{z}^{ } {\vert {λ}_{z} \vert}_{2} ( 6 )\end{matrix} \qquad ( 5 )$$

where α=0.5 and β=0.5 are optimal for the regularization of the parameters of the model. We do not add regularizers to A.

Probit Model for Category Prediction

Instead of modeling p(z|x) using logistic regression, we find it useful to use probit regression, which can be easier to handle from a generative model point of view. We use an auxiliary variable YεR^{C×N} that we regress onto with data x and the parameters (regressors) wεR^{C×N}. Following a conventional noise model ε: N(0,1), which results in y_{ci}=w_{c}φ(xᵢ)+ε, with w_{c} the 1×N row vector of class c regressors and φ(xᵢ) the N×1 column vector of inner products for the ith element, leads to the following Gaussian probability distribution:

p(y_{ci}|w_{c},φ(xᵢ))=N(w_{c}φ(xᵢ),1).

The link from the auxiliary variable y_{ci} to the discrete target category of interest zᵢε1, . . . , C is

zᵢ=j,if yᵢⱼ>y_{ij′},∀j≠j′,

and by the following marginalization

p(zᵢ: =J|w,φ(xᵢ))=∫p(tᵢ=j|yᵢ)p(yᵢ|w,φ(x))dyᵢ,

where p(zᵢ=j|yᵢ) is a delta function, results in the multinomial probit likelihood

$$p ( {z}_{i} = j \vert w , φ ( x ) ) = 𝔼 \{ {\prod }_{{j}^{′} \neq j}^{ } Φ ( u + ( {w}_{j} - {w}_{{j}^{′}} ) φ ( {x}_{i} ) ) \} ,$$

where E is the expectation taken with respect to the conventional normal distribution

p(u)=N(0,1) and Φ

is the normal cumulative density function.

Category Prediction Model

Recall, we have {xᵢ,sᵢ}ᵢ₌₁^{N}, where xᵢεR^{D} is the D-dimensional feature vector and sᵢ is the location of the end point. We want to predict the category for each time i. For each category, we can construct either a linear classifier or a non-linear classifier. For linear case, φ(xᵢ₎=xᵢ, and for the non-linear case, φ(xᵢ)=[K(xᵢ,x₁),K(xᵢ,x₂), . . . , K(xᵢ,x_{N})] where K(.,.) is a kernel function.

The regressors w_{ic} follow a conventional normal distribution with zero mean and variance α_{ic}⁻¹ where α_{ic} follows a Gamma distribution with hyperparameters τ,v. By setting τ,v to be sufficiently small values, e.g., (<10⁻⁵), only a small subset of the regressors w_{nc} are non-zero, subsequently leading to sparsity.

We assume that for each category c, there is a unique distribution μ_{c} over the destination {\hat{d}ₙ}_{nεL}_{_{c}}, where L_{c} is the inferred destinations 153 whose categories include c, and \hat{d}ₙ denotes the destination indexed as n.

The model of the final destination dᵢ is obtained from a multinomial-Dirichlet (Dir) distribution. With the assumption that one parks the vehicle near the destination. We model sᵢ using a Gaussian distribution with the mean of the location of the selected destination dᵢ, and variance σ²I₂, σ² can be fixed or further imposed with a Gamma prior probability.

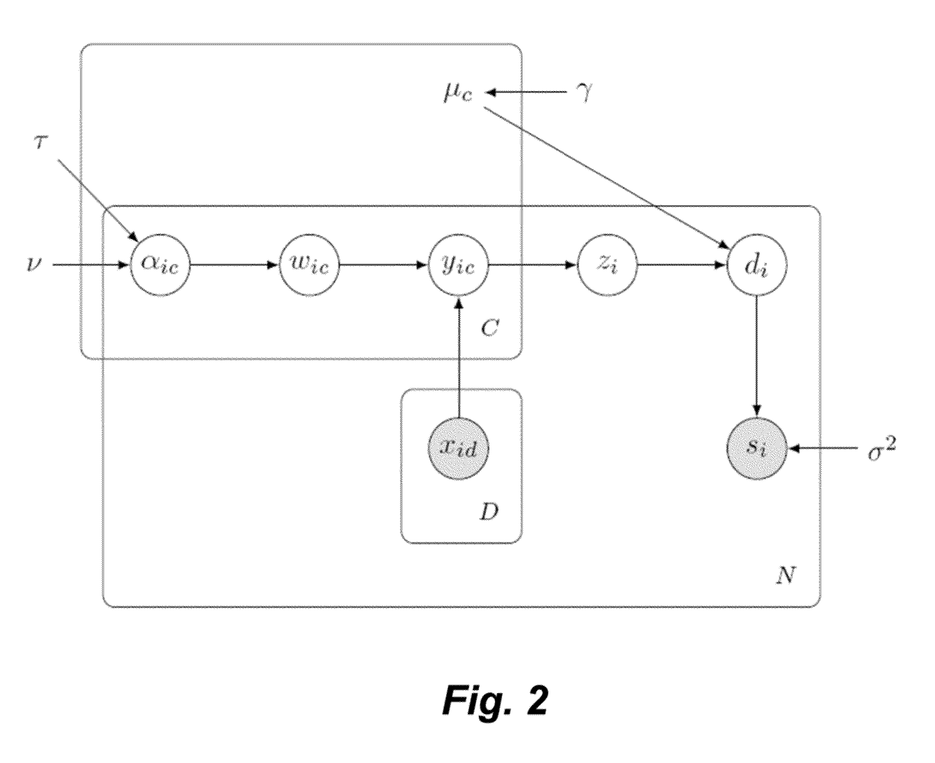

FIG. 2 shows our model graphically with the variables as described herein and summarized as follows:

$$\begin{matrix}{y}_{ic} \sim 𝒩 ( {w}_{c}^{T} φ ( {x}_{i} ) , 1 ) \\ {w}_{c} \sim 𝒩 ( 0 , {α}_{ic}^{- 1} ) \\ {α}_{ic} \sim Gamma ( τ , v ) \\ {z}_{i} = c , if {y}_{ic} > {y}_{ij} , ∀ c \neq j \\ {d}_{i} \sim {\sum }_{n ∈ {ℒ}_{{d}_{i}}}^{ } {μ}_{{d}_{i} n} {δ}_{{\hat{d}}_{n}} \\ {μ}_{c} \sim Dir ( \frac{γ}{\vert {ℒ}_{c} \vert} , … , \frac{γ}{\vert {ℒ}_{c} \vert} ) \\ {s}_{i} \sim 𝒩 ( {loc}_{( {d}_{i} )} , {σ}^{2} {I}_{2} ) \\ {σ}^{2} \sim InverseGamma ( {a}_{0} , {b}_{0} )\end{matrix}$$

We can also learn the parameters for each categorized destination as a user preference. However, this may take more training data to learn. In this case, we need to include a hierarchy of information about the categorized destinations to constrain this further. For example we can have a “genre” g, and a “name” or “brand” b, (e.g., “starbucks” versus “dunkin donuts”), and the actual destination d, e.g., a particular “starbucks” at a particular address. We can formulate these as a tree structure: c→g→b→d, and the relationships can be deterministic. bεbrand(d), gεgenre(b), cεcat(g).

We formulate these as sets in case there are more than one tags associated with each item, but in general each item in the tree has a single parent. This way the user's preferences for genres and brand names can be included without having to learn parameters at the level of actual locations d.

$$p ( b \vert g ) ∝ \{ \begin{matrix}{π}_{b \vert g} & g ∈ genre ( b ) \\ 0 & otherwise\end{matrix} ,$$

We can also include other users data, so we can formulate a global prior

p(π)=Dir(π;γ),

to constrain these probabilities.

Location Prediction

If we want to predict the next location to which a user will travel from previous locations, then we can consider clustering locations to reduce the complexity of inference. We use a discrete set of clustered regions, rεR. We can infer the current region rᵢ given previous regions using an N-gram based Markov model p(rᵢ|rᵢ₋₁, rᵢ₋₂, . . . , rᵢ₋ₙ₊₁), where n is the order of the Markov model, and an N-gram is the sequence of regions, rᵢ,rᵢ₋₁,rᵢ₋₂, . . . ,rᵢ₋ₙ₊₁. N-gram models can be smoothed to provide probabilities for unseen N-grams.

We can also consider a model in which users travels to nearby regions:

$$p ( {r}_{i} \vert {r}_{i - 1} ) = \frac{𝒩 ( loc ( {r}_{i} ) \vert loc ( {r}_{i - 1} ) , {\sum }_{region}^{ } )}{{\sum }_{{r}_{i}^{′}}^{ } 𝒩 ( loc ( {r}_{i}^{′} ) \vert loc ( {r}_{i - 1} ) , {\sum }_{region}^{ } )} .$$

We can also consider combining these via an auxiliary random variable oᵢ which indicates whether the user travels to nearby locations, or via the Markov dynamics above:

$$p ( {r}_{i} \vert {o}_{i} , {r}_{i - 1} ) = \{ \begin{matrix}\frac{𝒩 ( loc ( {r}_{i} ) \vert loc ( {r}_{i - 1} ) , {\sum }_{region}^{ } )}{{\sum }_{{r}_{i}^{′}}^{ } 𝒩 ( loc ( {r}_{i}^{′} ) \vert loc ( {r}_{i - 1} ) , {\sum }_{region}^{ } )} & {o}_{i} = 1 \\ {π}_{ri \vert {r}_{i - 1}} & otherwise\end{matrix} ,$$

Combining this with a prior probability p(oᵢ), and assuming that the rᵢ are observed, we can optimize the objective function to learn πᵣ_{ᵢ}_{|r}_{_{i−1}}:

$$\begin{matrix}log p ( {r}_{i} ) = & {\sum }_{i}^{ } log {\sum }_{{o}_{i}}^{ } p ( {o}_{i} ) p ( {r}_{i} \vert {o}_{i} , {r}_{i - 1} ) \\ & \geq {\sum }_{i}^{ } {\sum }_{{o}_{i}}^{ } q ( {o}_{i} ) ( \begin{matrix}log p ( {o}_{i} ) + log p ( {r}_{i} \vert {o}_{i} , {r}_{i - 1} ) - \\ log q ( {o}_{i} )\end{matrix} ) . ( 8 )\end{matrix} \qquad ( 7 )$$

Because of the redundancy between the two components, it may not work well to learn p(oᵢ), and may be better to set it using cross-validation, or to place a Dirichlet prior probability on it to favor a uniform distribution.

Discriminative Model for Region Prediction

It may be difficult to combine other context features, such as time of day and so on in an N-gram model for region prediction. As an alternative, we can use a classifier based approach such as a logistic regression or the probit regression model described above. In this case, we can define p(rᵢ|xᵢ) in a similar way as p(zᵢ|xᵢ). The features xᵢ in this case contains features representing the previous destinations rᵢ₋₁,rᵢ₋₂, . . . , rᵢ₋ₙ₊₁, in addition to any other features used for category prediction.

Location Dependence for Destination Category Selection

We can also model the dependency between the predicted region r, predicted category z, and the destination d. The region prediction and category prediction can be combined through a destination likelihood as follows:

$$p ( {d}_{i} \vert {r}_{i} , {z}_{i} ) ∝ \{ \begin{matrix}𝒩 ( loc ( {d}_{i} ) \vert loc ( {r}_{i} ) , {\sum }_{dest}^{ } ) & {z}_{i} ∈ cat ( {d}_{i} ) \\ 0 & otherwise\end{matrix} ,$$

Destination Database Dependency

We can have more than one destination database 150 and the databases can have different importance in determining user destinations. In particular, users can have a collection of “favorite” destinations. Here, we treat these as a database of destinations that has a higher prior probability than those from a generic database. Therefore, we use a multinomial random variable f₁: Mult (λ) that indicates the database selected by the user for predicting a destination for trip segment i. To implement the selection of the destination database, we define the set L_{c,k} as the library of the destinations from database k whose categories include c. Then

$${d}_{i} \text{:} {\sum }_{n ∈ {L}_{{z}_{i} , {f}_{i}}} {μ}_{{d}_{i} n} {δ}_{{\hat{d}}_{n}} ,$$

where \hat{d}ₙ denotes the destination indexed as n.

The data is assumed to be distributed according to the model:

destination index probability λ:Dirichlet(η)

variance parameter σ²:InverseGamma(c₀,d₀)

destination probability μ_{c}:Dirichlet(γ)

regressor w_{c}: N(0, α_{c}⁻¹I_{N})Gamma(α_{c}; a₀,b₀)

For each point i=1, . . . , N
destination database index fᵢ:Multinomial (λ)
latent variable y_{ic}:N(w_{c}^{T}φ(xᵢ),1)
index zᵢ=c if y_{ic}>yᵢⱼ∀c≠j
destination

$${d}_{i} \text{:} {\sum }_{n ∈ {L}_{{z}_{i} , {f}_{i}}} {μ}_{{d}_{i} n} {δ}_{{\hat{d}}_{n}}$$

parking location sᵢ: N(loc(dᵢ), σ²I₂)

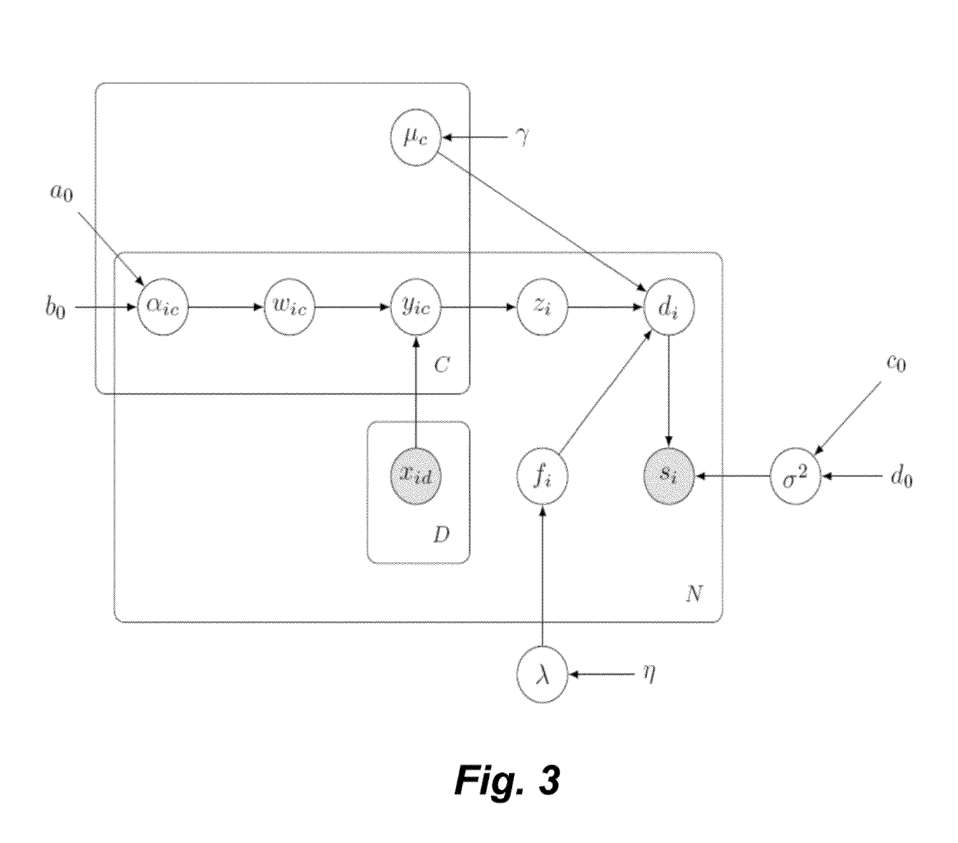

FIG. 3 shows a destination category prediction model with destination database dependency with variable as defined herein.

Unsupervised Region Modeling

In the above model, regions are treated as pre-defined locations derived either by tiling the geographic space, or clustering destinations and/or locations frequently traveled to by users. It is a reasonable extension to consider the spatial distribution over destination locations as a region model. In this case, the locations of the regions can be learned in the context of the model in an unsupervised way.

Trajectory Modeling

In the above model, location prediction is based on region history. The prediction can also be based on geographic features including direction of travel, road segments, distance along route, ease of navigation to destinations given current route and map information, traffic information. Such modeling is a reasonable extension of the method, to improve prediction and generalization to new locations.

Although the invention has been described by way of examples of preferred embodiments, it is to be understood that various other adaptations and modifications can be made within the spirit and scope of the invention. Therefore, it is the object of the appended s to cover all such variations and modifications as come within the true spirit and scope of the invention.

1. A method for predicting destinations during travel comprising steps:
inferring, based on previous states of the travel, probabilities of having traveled to destinations and destination categories in the past;
predicting, based on feature vectors representing current states of the travel, probabilities of categories of the destinations using a predictive model based on previous states of the travel and the destinations and destination categories, wherein the feature vectors include vehicle navigation data, vehicle system bus data, weather data, and derived data;
regularizing parameters of the predictive model;
transforming the feature vectors to a lower-dimensional subspace; and
outputting a subset of the categories with highest probabilities for user selection, wherein the steps are performed in a processor.

2. (canceled)

3. The method of claim 1, wherein the predictive model is based on an N-gram.

4. The method of claim 1, wherein the model is a probability+unit (probit) regression model, where dependent variable can only take two values.

5. (canceled)

6. The method of claim 1, wherein the predicting uses a probabilistic model.

7. The method of claim 1, predicting the destinations using a multinomial distribution.

8. The method of claim 1, wherein categories include hierarchies of genres, names, and destinations.

9. The method of claim 1, wherein the predicting uses a combination of databases of destinations, and a history of locations.
